(19) United States
(12) Patent Application Publication
(10) Pub. No.: US 2013/0186289 A1
(43) Pub. Date: Jul. 25, 2013

(54) LEMON JUICER DEVICE

(71) Applicant: Fernando Garcia, Oswego, IL (US)

(72) Inventor: Fernando Garcia, Oswego, IL (US)

(21) Appl. No.: 13/355,553

(22) Filed: Jan. 22, 2012

(51) Int. Cl. B30B 9/02

(52) U.S. Cl. 100/131

(57) ABSTRACT

The present invention is a lemon juicer device to juice a half lemon that includes a bottom spoon-shaped base with a cup portion that includes 4 metal cutting blades and a plurality of apertures disposed on the cup portion and a handle portion, a top spoon-shaped press with a cup portion that includes a plurality of slots that correspond to the cutting blades and a handle portion and an ejector plate disposed in the front of the cup portion of the bottom spoon-shaped press. There is also an attachment indentation and an attachment protrusion where the attachment indentation and the attachment protrusion can be mated and snapped together to secure the cup portion of the bottom spoon-shaped base and the cup portion of the top spoon-shaped press together and a hinge that swingably attaches the bottom spoon-shaped base to the top spoon-shaped press.

### TECHNICAL FIELD & BACKGROUND

Most traditional manual lemon juicers have basically a similar design of a cup that holds a lemon that is used to apply pressure to crush the lemon to extract any lemon juice requiring relatively heavy pressure to be applied to the lemon due to the crushing and stretching action.

The present invention generally relates to a juicer device. More specifically, the invention is a lemon juicer device.

It is an object of the invention to provide a lemon juicer device that requires relatively less exerted pressure to produce lemon juice from a lemon.

It is an object of the invention to provide a lemon juicer device that reduces tension on a lemon being squeezed with strategically placed blades that cut the lemon in quarters as pressure is applied to the lemon being squeezed.

It is an object of the invention to provide a lemon juicer device that utilizes an ejector arm to facilitate ejecting a lemon.

What is really needed is a lemon juicer device that requires relatively less exerted pressure to produce lemon juice from a lemon that reduces tension on a lemon being squeezed with strategically placed blades that cut the lemon in quarters as pressure is applied to the lemon being squeezed that utilizes an ejector arm to facilitate squeezing a lemon.

### BRIEF DESCRIPTION OF THE DRAWINGS

The present invention will be described by way of exemplary embodiments, but not limitations, illustrated in the accompanying drawing in which like references denote similar elements, and in which:

FIG. 1A illustrates a side perspective view of a lemon juicer device in a closed position, in accordance with one embodiment of the present invention.

FIG. 1B illustrates an overhead perspective view of a lemon juicer device in an open position, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

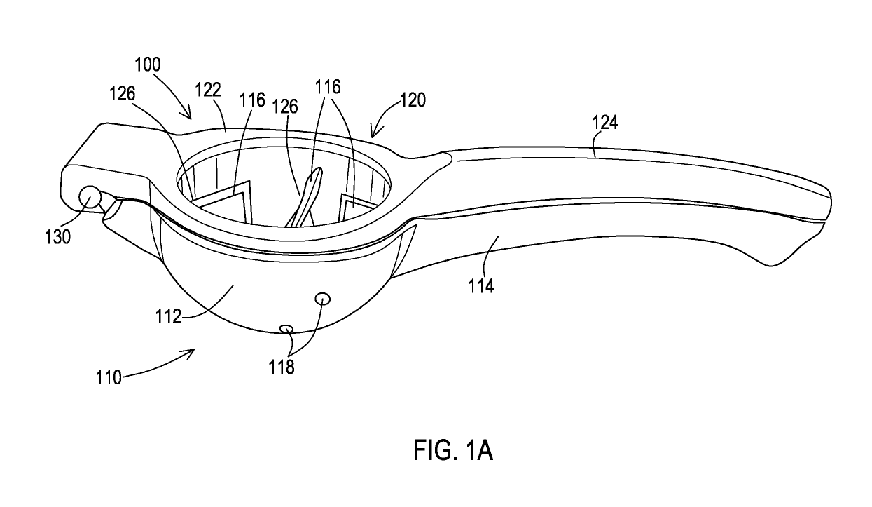

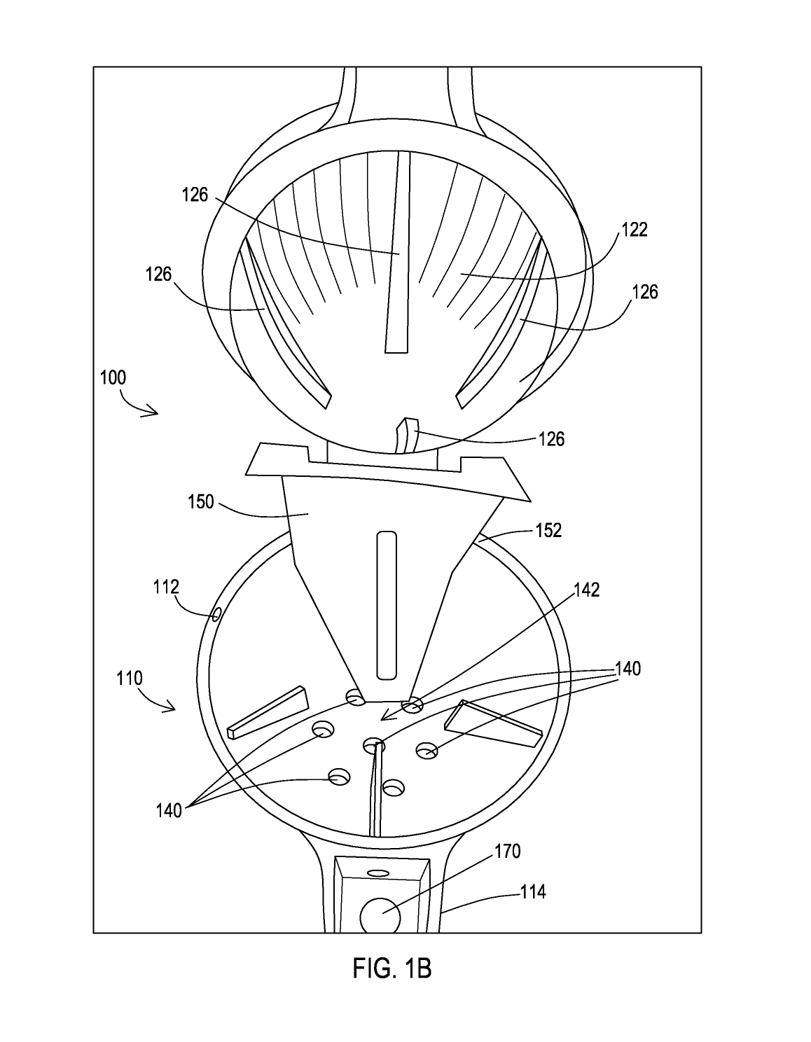

FIG. 1A illustrates a side perspective view of a lemon juicer device 100 in a closed position, in accordance with one embodiment of the present invention.

The lemon juicer device 100 includes a bottom spoon-shaped base 110, a top spoon-shaped press 120 and a hinge 130. The bottom spoon-shaped base 110 has a cup portion 112 and a handle portion 114. The cup portion 112 has a plurality of cutting blades 116 that are disposed on the cup portion 112. The cutting blades 116 include 4 metal cutting blades that are equal distance from each other, although any suitable number and type of cutting blades 116 in any suitable orientation can be utilized. Additional details regarding the cutting blades 116 are provided in FIG. 1B and its descriptions. The cutting blades 116 are secured to the cup portion 112 with one or more rivets 118 or other suitable fastener. The top spoon-shaped press 120 has a cup portion 122 and a handle portion 124 that can be fittingly swung and pressed into the cup portion 112 of the bottom spoon-shaped base 110. The cup portion 122 of the spoon-shaped press 120 is slightly smaller than the cup portion 112 of the bottom spoon-shaped base 110 and fittingly corresponds to the cup portion 112 of the bottom spoon-shaped base 110. The cup portion 122 has a plurality of slots 126 that correspond to the position and orientation of the cutting blades 116. The cutting blades 116 extend through the slots 126 as the cup portion 122 of the top spoon-shaped press 120 is pressed into the cup portion 112 of the bottom spoon-shaped base 110. The hinge 130 swingably attaches the bottom spoon-shaped base 110 to the top spoon-shaped press 120. A half lemon with the pulp facing upward is typically placed in the cup portion 112 of the bottom spoon-shaped base 110 and the top spoon-shaped press 120 is swung downward onto the lemon with the cup portion 122 of the top spoon-shaped press 120 making contact with the lemon and exerting pressure onto the lemon thereby producing lemon juice. The cutting blades 116 cut the lemon into 4 quarters while the lemon is in the cup portion 112 of the bottom spoon-shaped base 110. This results in relatively less pressure needing to be applied to the lemon to generate squeezed lemon juice. Also because the cut quartered lemon has a greater surface area than a full half uncut lemon, more juice will also be generated than from a whole lemon. Typically the lemon juicer device 100 is made of durable metal material, although the lemon juicer device 100 can be made of other suitable material as well.

FIG. 1B illustrates an overhead perspective view of a lemon juicer device 100 in an open position, in accordance with one embodiment of the present invention. The lemon juicer device 100 illustrated in FIG. 1B has all of the same features as the lemon juicer device 100 illustrated in FIG. 1A.

The lemon juicer device 100 additionally includes a plurality of apertures 140, an ejector plate 150, an attachment indentation 160 and an attachment protrusion 170. The apertures 140 are disposed on a bottom portion 142 of the cup portion 112 of the bottom spoon-shaped base 110 and are utilized to allow lemon juice generated from the lemon juicer device 100 to run through the apertures 140 to be collected. There are 7 apertures 140 illustrated in FIG. 1B positioned in a circular orientation however any suitable number or orientation of apertures 140 can be disposed on the bottom portion 142 of the cup portion 112 of the lemon juicer device 100. The ejector plate 150 is disposed in front 152 of the cup portion 112 of the bottom spoon-shaped base 110 and assists in removing the lemon after the lemon has been squeezed and juiced. Typically the ejector plate 150 provides space between the cup portion 112 of the bottom spoon-shaped base 110 and the lemon and allows a user to more easily pick the lemon out of the cup portion 112 of the bottom spoon-shaped base 110 after the lemon has been squeezed and juiced. The attachment indentation 160 is disposed between the cup portion 112 and the handle portion 114 of the bottom spoon-shaped base 110. The attachment protrusion 170 is disposed between the cup portion 122 and the handle portion 124 of the top spoon-shaped press 120. The attachment indentation 160 and the attachment protrusion 170 can be mated and snapped to secure the cup portion 112 of the bottom spoon-shaped base 110 and the cup portion 122 of the top spoon-shaped press 120 together with or without a lemon in the cup portion 112 of the bottom spoon-shaped base 110.

The lemon juicer device allows squeezing a lemon to release the lemon juice without needing heavy pressure as is required with traditionally designed lemon juicers. Most traditional manual lemon juicers have basically the same design with a cup that holds a lemon and that is used to apply pressure to crush the lemon to extract the juice requiring heavy pressure to be applied to the lemon due to the crushing and stretching action. The lemon juicer device will reduce the amount of pressure needed to extract lemon juice. The design reduces the tension on the lemon with strategically placed blades that cut the lemon in quarters as pressure is applied, the ability to cut the lemon in quarters as pressure is applied to reduce the stress on the lemon rein allowing a reduction in stress on the lemon rein which in turn allows for smooth consistent pressure to release the juice. The addition of the cutting blades in the lemon squeezer reduces the amount of pressure needed to extract the juice from the lemon by cutting the lemon in quarters in which release the stress that the other lemon squeezers are forced to address by stretching or crushing the lemon whole. The placement of four blades that cut the lemon in quarters as it is being squeezed and an ejector arm that will eject the used lemon upon full opening of the lemon juicer will prevent the user from coming in contact with the cutting blades.

The user will cut a lemon in half and then place one of the halves in the lemon juicer where the juicer will automatically start to cut the lemon half in quarters as the user applies pressure. After the user finishes extracting the juice and opens the juicer an ejector blade is raised on the opening cycle, ejecting the used lemon without the user coming in contact with the cutting blades.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A lemon juicer device to juice a half lemon, comprising:
a bottom spoon-shaped base with a cup portion with a bottom and a front that includes a plurality of cutting blades and a plurality of apertures disposed on said bottom of said cup portion and a handle portion;
a top spoon-shaped press with a cup portion that includes a plurality of slots that correspond to said cutting blades and a handle portion that can be fittingly swung and pressed into said cup portion of said bottom spoon-shaped base;
an ejector plate disposed in said front of said cup portion of said bottom spoon-shaped base and that assists in removing said lemon after said lemon has been squeezed and juiced; and
a hinge that swingably attaches said bottom spoon-shaped base to said top spoon-shaped press.

2. The device according to claim 1, wherein said apertures include 7 apertures positioned in a circular orientation to allow lemon juice generated from said lemon juicer device to run through said apertures to be collected.

3. The device according to claim 1, wherein said cutting blades include 4 metal cutting blades that cut said lemon into 4 quarters.

4. The device according to claim 1, wherein said cutting blades are equal distanced.

5. The device according to claim 1, wherein said cutting blades are secured to said cup portion with one or more rivets.

6. The device according to claim 1, wherein said cup portion of said spoon-shaped press is slightly smaller than said cup portion of said bottom spoon-shaped base and fittingly corresponds to said cup portion of said bottom spoon-shaped base.

7. The device according to claim 1, wherein said ejector plate provides space between said cup portion of said bottom spoon-shaped base.

8. A lemon juicer device to juice a half lemon, comprising:
a bottom spoon-shaped base with a cup portion with a bottom and a front that includes 4 metal cutting blades and a plurality of apertures disposed on said bottom of said cup portion and a handle portion;
a top spoon-shaped press with a cup portion that includes a plurality of slots that correspond to said cutting blades and a handle portion that can be fittingly swung and pressed into said cup portion of said bottom spoon-shaped base;
an ejector plate disposed in said front of said cup portion of said bottom spoon-shaped base that assists in removing said lemon after said lemon has been squeezed and juiced;
an attachment indentation disposed between said cup portion and said handle portion of said bottom spoon-shaped base;
an attachment protrusion disposed between said cup portion and said handle portion of said top spoon-shaped press, wherein said attachment indentation and said attachment protrusion can be mated and snapped together to secure said cup portion of said bottom spoon-shaped base and said cup portion of said top spoon-shaped press together; and
a hinge that swingably attaches said bottom spoon-shaped base to said top spoon-shaped press.

9. The device according to claim 8, wherein said cutting blades are equal distanced.

10. The device according to claim 9, wherein said cutting blades cut said lemon into 4 quarters.

11. The device according to claim 8, wherein said apertures include 7 apertures positioned in a circular orientation to allow lemon juice generated from said lemon juicer device to run through said apertures to be collected.

12. The device according to claim 8, wherein said cutting blades are secured to said cup portion with one or more rivets.

13. The device according to claim 8, wherein said cup portion of said spoon-shaped press is slightly smaller than said cup portion of said bottom spoon-shaped base and fittingly corresponds to said cup portion of said bottom spoon-shaped base.

14. The device according to claim 8, wherein said ejector plate provides space between said cup portion of said bottom spoon-shaped base.

15. A lemon juicer device to juice a half lemon, comprising:
a bottom spoon-shaped base with a cup portion with a bottom and a front that includes 4 equal distanced metal cutting blades that are secured to said cup portion with one or more rivets and a plurality of apertures disposed on said bottom of said cup portion and a handle portion;
a top spoon-shaped press with a cup portion that includes a plurality of slots that correspond to said cutting blades and a handle portion that can be fittingly swung and pressed into said cup portion of said bottom spoon-shaped base;
an ejector plate disposed in said front of said cup portion of said bottom spoon-shaped base that assists in removing said lemon after said lemon has been squeezed and juiced;
an attachment indentation disposed between said cup portion and said handle portion of said bottom spoon-shaped base;
an attachment protrusion disposed between said cup portion and said handle portion of said top spoon-shaped press, wherein said attachment indentation and said attachment protrusion can be mated and snapped together to secure said cup portion of said bottom spoon-shaped base and said cup portion of said top spoon-shaped press together; and
a hinge that swingably attaches said bottom spoon-shaped base to said top spoon-shaped press.

16. The device according to claim 15, wherein said cutting blades cut said lemon into 4 quarters.

17. The device according to claim 15, wherein said apertures include 7 apertures positioned in a circular orientation to allow lemon juice generated from said lemon juicer device to run through said apertures to be collected.

18. The device according to claim 15, wherein said cup portion of said spoon-shaped press is slightly smaller than said cup portion of said bottom spoon-shaped base and fittingly corresponds to said cup portion of said bottom spoon-shaped base.

19. The device according to claim 15, wherein said ejector plate provides space between said cup portion of said bottom spoon-shaped base.

20. The device according to claim 15, wherein said device is made of durable metal.
